(19) United States
(12) Patent Application Publication
(10) Pub. No.: US 2014/0245463 A1
(43) Pub. Date: Aug. 28, 2014

(54) SYSTEM AND METHOD FOR ACCESSING MULTIMEDIA CONTENT

(71) Applicant: Samsung Electronics Co., Ltd., Suwon-si (KR)

(72) Inventors: Vinoth SURYANARAYANAN, Tamil Nadu (IN); M. Sabarimala MANIKANDAN, Tamil Nadu (IN); Saurabh TYAGI, Uttar Pradesh (IN)

(73) Assignee: Samsung Electronics Co., Ltd., Suwon-si (KR)

(21) Appl. No.: 14/193,959

(22) Filed: Feb. 28, 2014

(30) Foreign Application Priority Data
Feb. 28, 2013 (IN) 589/DEL/2013

(51) Int. Cl. G06F 3/0484; G06F 21/31

(52) U.S. Cl. CPC G06F 3/0484; G06F 21/31
USPC 726/28; 715/716

(57) ABSTRACT

A systems and method for accessing multimedia content are provided. The method for accessing multimedia content includes receiving a user query for accessing multimedia content of a multimedia class, the multimedia content being associated with a plurality of multimedia classes and each of the plurality of multimedia classes being linked with one or more portions of the multimedia content, executing the user query on a media index of the multimedia content, identifying portions of the multimedia content tagged with the multimedia class based on the execution of the user query, retrieving a tagged portion of the multimedia content tagged with the multimedia class based on the execution of the user query, and transmitting the tagged portion of the multimedia content to the user through a mixed reality multimedia interface.

### CROSS-REFERENCE TO RELATED APPLICATION(S)

This application claims the benefit under 35 U.S.C. §119(a) of an Indian patent application filed on Feb. 28, 2013 in the Indian Intellectual Property Office and assigned Serial number 589/DEL/2013, the entire disclosure of which is hereby incorporated by reference.

### TECHNICAL FIELD

The present disclosure relates to accessing multimedia content. More particularly, the present disclosure relates to systems and methods for accessing multimedia content based on metadata associated with the multimedia content.

### BACKGROUND

Generally a user receives multimedia content, such as audio, pictures, video and animation, from various sources including broadcasted multimedia content and third party multimedia content streaming portals. The multimedia content may be associated with various tags or keywords to facilitate the user to search and view the content of his choice or interest. Usually the visual and the audio tracks of the multimedia content are analyzed to tag the multimedia content into broad categories or genres, such as news, TV shows, sports, films, and commercials.

In certain cases, the multimedia content may be tagged based on the audio track of the multimedia content. For example, the audio track may be tagged with one or more multimedia classes, such as jazz, electronic, country, rock, and pop, based on the similarity in rhythm, pitch and contour of the audio track with the multimedia classes. In some situations, the multimedia content may also be tagged based on the genres of the multimedia content. For example, the multimedia content may be tagged with one or more multimedia classes, such as action, thriller, documentary and horror, based on the similarities in the narrative elements of the plot of the multimedia content with the multimedia classes.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide systems and methods for accessing multimedia content based on metadata associated with the multimedia content.

In accordance with an aspect of the present disclosure, a method for accessing multimedia content is provided. The method includes receiving a user query for accessing multimedia content of a multimedia class, the multimedia content being associated with a plurality of multimedia classes and each of the plurality of multimedia classes being linked with one or more portions of the multimedia content, executing the user query on a media index of the multimedia content, identifying portions of the multimedia content tagged with the multimedia class based on the execution of the user query, retrieving a tagged portion of the multimedia content tagged with the multimedia class is retrieved based on the execution of the user query, and transmitting the tagged portion of the multimedia content to the user through a mixed reality multimedia interface.

In accordance with an aspect of the present disclosure, a user device. The user device includes at least one device processor, a mixed reality multimedia interface coupled to the at least one device processor, the mixed reality multimedia interface configured to receive a user query from a user for accessing multimedia content of a multimedia class, retrieve a tagged portion of the multimedia content tagged with the multimedia class, and transmit the tagged portion of the multimedia content to the user.

In accordance with an aspect of the present disclosure, a media classification system is provided. The media classification system includes a processor, a segmentation module coupled to the processor, the segmentation module configured to segment multimedia content into its constituent tracks, a categorization module, coupled to the processor, the categorization module configured to extract a plurality of features from the constituent tracks, and classify the multimedia content into at least one multimedia class based on the plurality of features, an index generation module coupled to the processor, the index generation module configured to create a media index for the multimedia content based on the at least one multimedia class, and generate a mixed reality multimedia interface to allow a user to access the multimedia content, and a Digital Rights Management (DRM) module coupled to the processor, the DRM module configured to secure the multimedia content, based on digital rights associated with the multimedia content, wherein the multimedia content is secured based on a sparse coding technique and a compressive sensing technique using composite analytical and signal dictionaries.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1A schematically illustrates a network environment implementing a media accessing system according to an embodiment of the present disclosure.

FIG. 1B schematically illustrates components of a media classification system according to an embodiment of the present disclosure.

FIG. 2A schematically illustrates components of a media classification system according to another embodiment of the present disclosure.

FIG. 2B illustrates a decision-tree based classification unit according to an embodiment of the present disclosure.

FIG. 2C illustrates a graphical representation depicting performance of an applause sound detection method according to an embodiment of the present disclosure.

FIG. 2D illustrates a graphical representation depicting feature pattern of an audio track with laughing sounds according to an embodiment of the present disclosure.

FIG. 2E illustrates a graphical representation depicting performance of a voiced-speech pitch detection method according to an embodiment of the present disclosure.

FIGS. 3A, 3B, and 3C illustrate methods for segmenting multimedia content and generating a media index for multimedia content according to an embodiment of the present disclosure.

FIG. 4 illustrates a method for skimming the multimedia content according to an embodiment of the present disclosure.

FIG. 5 illustrates a method for protecting multimedia content from an unauthenticated and an unauthorized user according to an embodiment of the present disclosure.

FIG. 6 illustrates a method for prompting an authenticated user to access the multimedia content according to an embodiment of the present disclosure.

FIG. 7 illustrates a method for obtaining a feedback of the multimedia content from a user according to an embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Systems and methods for accessing multimedia content are described herein. The methods and systems, as described herein, may be implemented using various commercially available computing systems, such as cellular phones, smart phones, Personal Digital Assistants (PDAs), tablets, laptops, home theatre system, set-top box, Internet Protocol TeleVisions (IP TVs) and smart TeleVisions (smart TVs).

With the increase in volume of multimedia content, most multimedia content providers facilitate the user to search content of his interest. For example, the user may be interested in watching a live performance of his favorite singer. The user usually provides a query searching for multimedia files pertaining to live performances of his favorite singer. In response to the user's query, the multimedia content provider may return a list of multimedia files which have been tagged with keywords indicating the multimedia files to contain recordings of live performances of the user's favorite singer. In many cases, the live performances of the user's favorite singer may be preceded and followed by performances of other singers. In such cases, the user may not be interested in viewing the full length of the multimedia file. However, the user may still have to stream or download the full length of the multimedia file and then seek a frame of the multimedia file which denotes the start of the performance of his favorite singer. This leads to wastage of bandwidth and time as the user downloads or steams content which is not relevant for him.

In another example, the user may search for comedy scenes from films released in a particular year. In many cases, portions of a multimedia content, of a different multimedia class, may be relevant to the user's query. For example, even an action film may include comedy scenes. In such cases, the user may miss out on multimedia content which are of his interest. To reduce the chances of the user missing relevant content, some multimedia service providers facilitate the user, while browsing, to increase the playback speed of the multimedia file or display stills from the multimedia files at fixed time intervals. However, such techniques usually distort the audio track and convey very little information about the multimedia content to the user.

The systems and methods described herein, implement accessing multimedia content using various user devices, such as cellular phones, smart phones, PDAs, tablets, laptops, home theatre system, set-top box, IP TVs, and smart TVs. In one example, the methods for providing access to the multimedia content are implemented using a media accessing system. In said example, the media accessing system comprises a plurality of user devices and a media classification system. The user devices may communicate with the media classification system, either directly or over a network, for accessing multimedia content.

In one implementation, the media classification system may fetch multimedia content from various sources and store the same in a database. The media classification system initializes processing of the multimedia content. In one example, the media classification system may convert the multimedia content, which is in an analog format, to a digital format to facilitate further processing. In said example, the multimedia content is split into its constituent tracks, such as an audio track, a visual track, and a text track using techniques, such as decoding, and de-multiplexing. In one implementation, the text track may be indicative of subtitles present in a video.

In one implementation, the audio track, the visual track, and the text track, may be analyzed to extract low-level features, such as commercial breaks, and boundaries between shots in the visual track. In said implementation, the boundaries between shots may be determined using shot detection techniques, such as sum of absolute sparse coefficient differences, and event change ratio in sparse representation domain. The sparse representation or coding technique has been explained later in detail, in the description.

The shot boundary detection may be used to divide the visual track into a plurality of sparse video segments. The sparse video segments are further analyzed to extract high-level features, such as object recognition, highlight scene, and event detection. The sparse representation of high-level features may be used to determine semantic correlation between the sparse video segments and the entire visual track, for example, based on action, place and time of the scenes depicted in the sparse video segments. In one example, the sparse video segments may be analyzed using sparse based techniques, such as sparse scene transition vector to detect sub-boundaries.

Based on the sparse video analysis, the sparse video segments important for the plot of the multimedia content are selected as key events or key sub-boundaries. All the key events are synthesized to generate a skim for the multimedia content.

In another implementation, the visual track of the multimedia content may be segmented based on sparse representation and compressive sensing features. The sparse video segments may be clustered together, based on their sparse correlation, as key frames. The key frames may also be compared with each other to avoid redundant frames by means of determining sparse correlation coefficient. For example, similar or same frames representing a shot or a scene may be discarded by comparing sparse correlation coefficient metric with a predetermined threshold. In one implementation, the similarity between key frames may be determined based on various frame features, such as color histogram, shape, texture, optical flow, edges, motion vectors, camera activity, and camera motion. The key frames are analyzed to determine similarity with narrative elements of pre-defined multimedia classes to classify the multimedia content into one or more of the pre-defined multimedia classes based on sparse representation and compressive sensing classification models.

In one example, the audio track of the multimedia content may be analyzed to generate a plurality of audio frames. Thereafter, the silent frames may be discarded from the plurality of audio frames to generate non-silent audio frames, as the silent frames do not have any audio information. The non-silent audio frames are processed to extract key audio features including temporal, spectral, time-frequency, and high-order statistics. Based on the key audio features, the multimedia content may be classified into one or more multimedia classes.

In one implementation, the media classification system may classify the multimedia content into at least one multimedia class based on the extracted features. For example, based on sparse representation of perceptual features, such as laughter and cheer, the multimedia content may be classified into the multimedia class named as “comedy”. Further, the media classification system may generate a media index for the multimedia content based on the at least one multimedia class. For example, an entry of the media index may indicate that the multimedia content is “comedy” for duration of 2:00-4:00 minutes. In one implementation, the generated media index may be stored within the local repository of the media classification system.

In operation, according to an implementation, a user may input a query to media classification system using a mixed reality multimedia interface, integrated in the user device, seeking access to the multimedia content of his choice. The multimedia content may be associated with various tags or keywords to facilitate the user to search and view the content of his choice. For example, the user may wish to view all comedy scenes of movies released in the past six months. Upon receiving the user query, the media classification system may retrieve tagged portion of the multimedia content tagged with the multimedia class by executing the query on the media index and transmit the same to the user device for being displayed to the user. The tagged portion of the multimedia content may be understood as the list of relevant multimedia content for the user. The user may select the content which he wants to view. According to another implementation, the mixed reality multimedia interface may be generated by the media classification system.

Further, the media classification system would transmit only the relevant portions of the multimedia content and not the whole file storing the multimedia content, thus saving the bandwidth and download time of the user. In one example, the media classification system may also prompt the user to rate or provide his feedback regarding the indexing of the multimedia content. Based on the received rating or feedback, the media classification system may update the media index. In one implementation, the media classification system may employ machine learning techniques to enhance classification of multimedia content based on the user's feedback and rating. In one example, the media classification system may implement digital rights management techniques to prevent unauthorized viewing or sharing of multimedia content amongst users.

The above systems and methods are further described in conjunction with the following figures. It should be noted that the description and figures merely illustrate the principles of the present subject matter. Further, various arrangements may be devised that, although not explicitly described or shown herein, embody the principles of the present subject matter and are included within its spirit and scope.

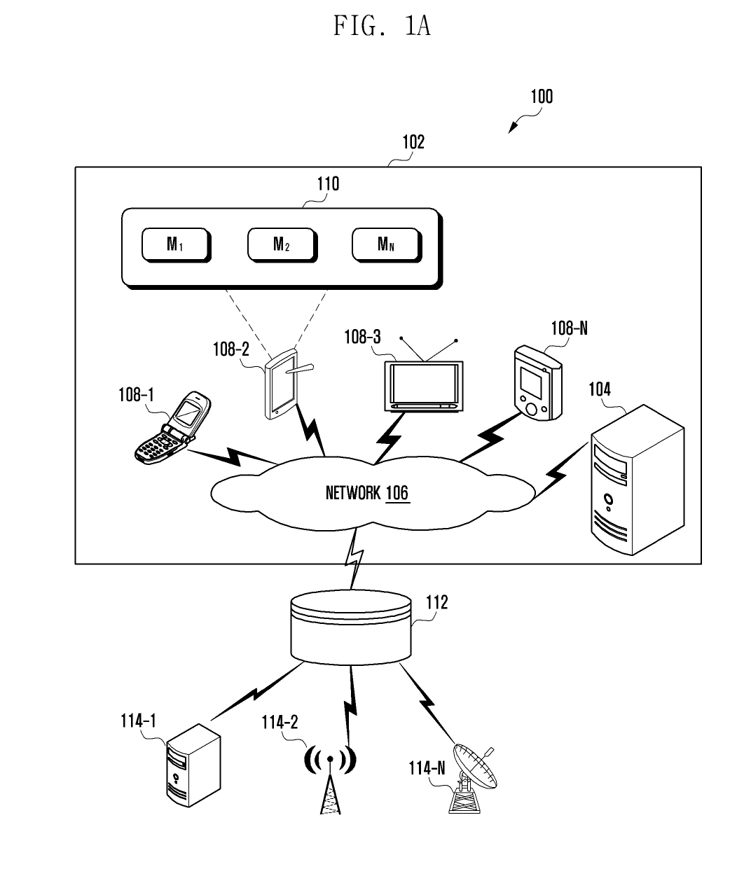

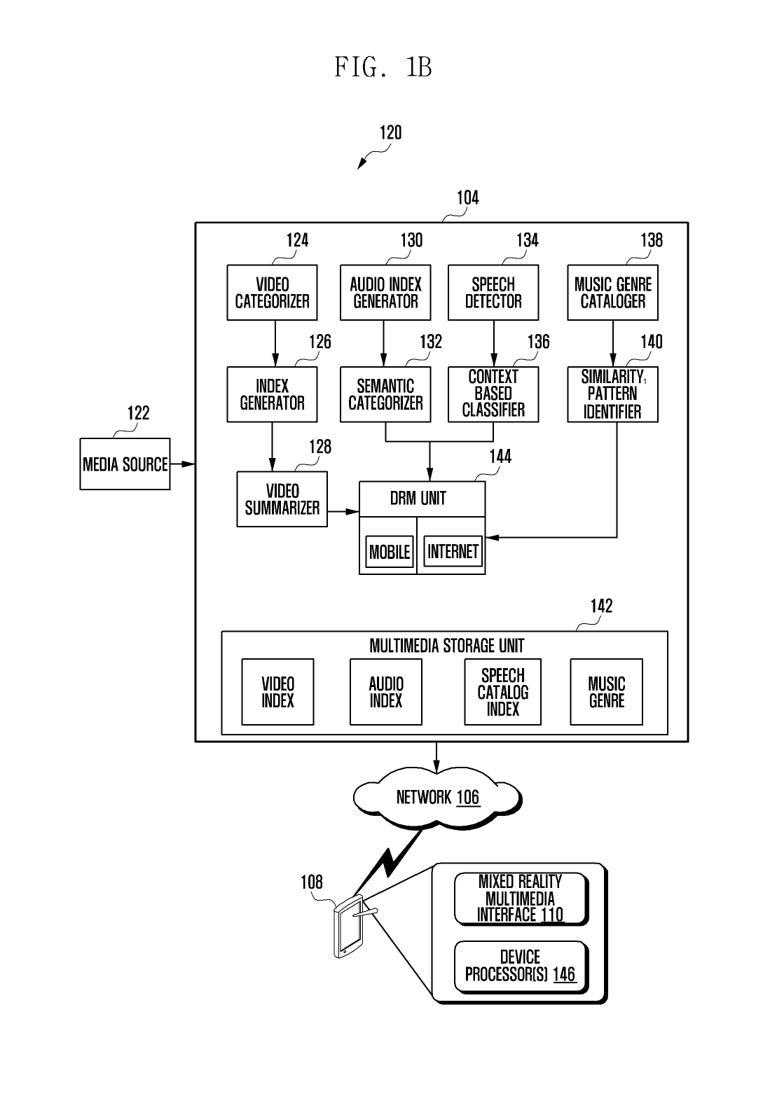

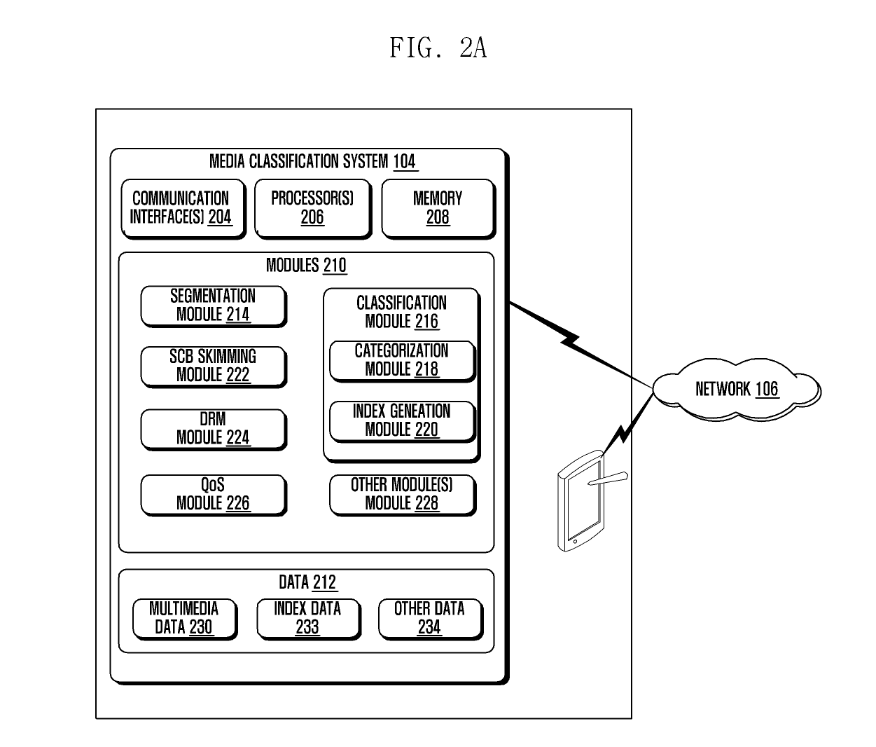

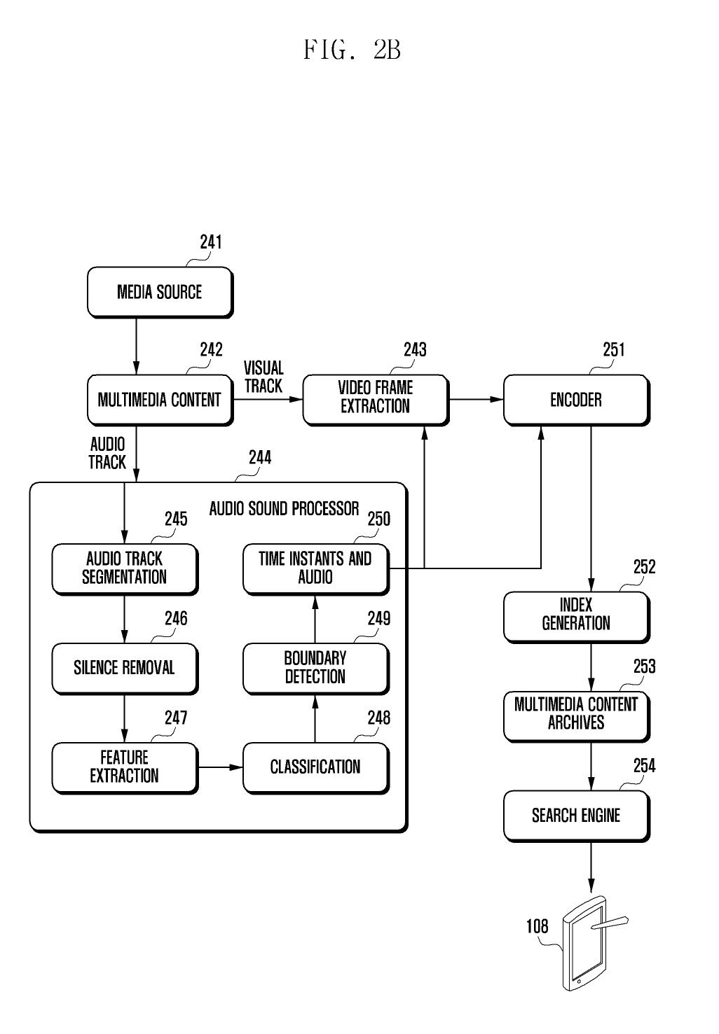

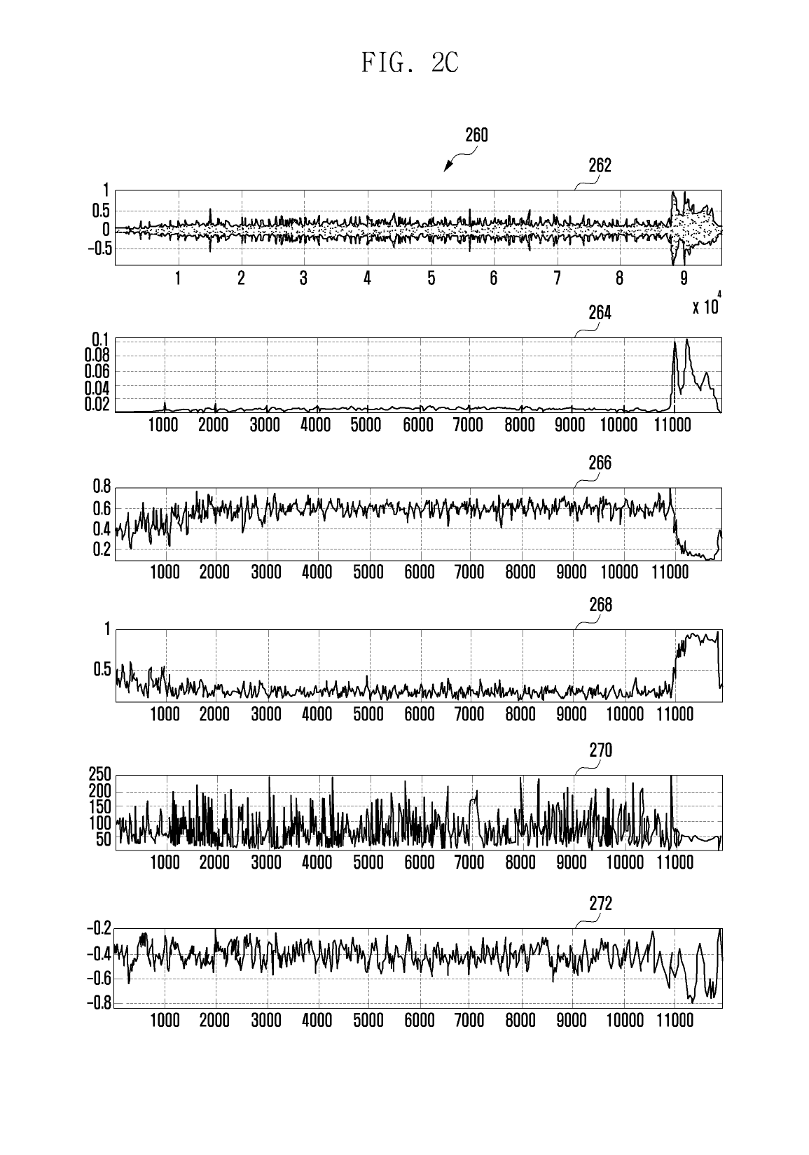

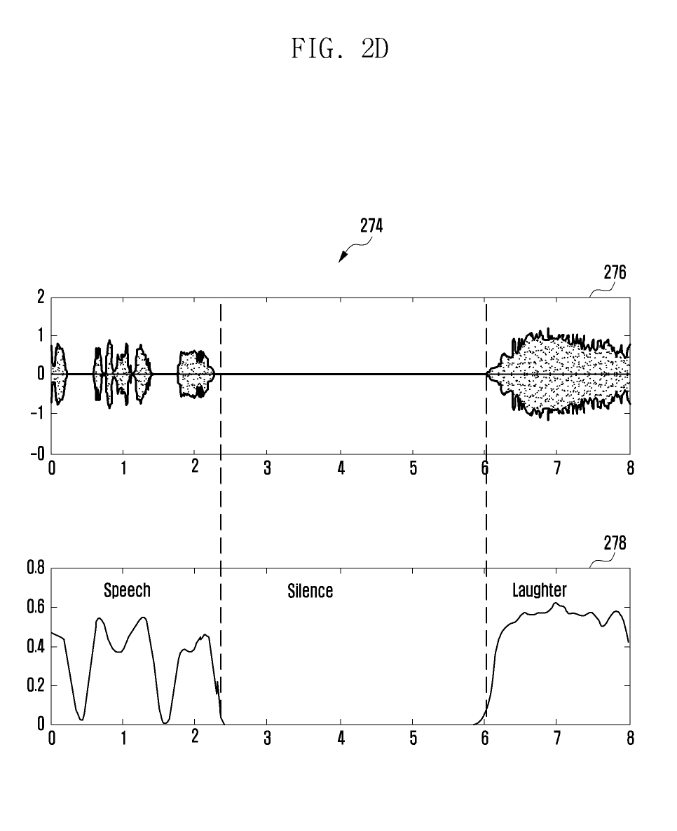

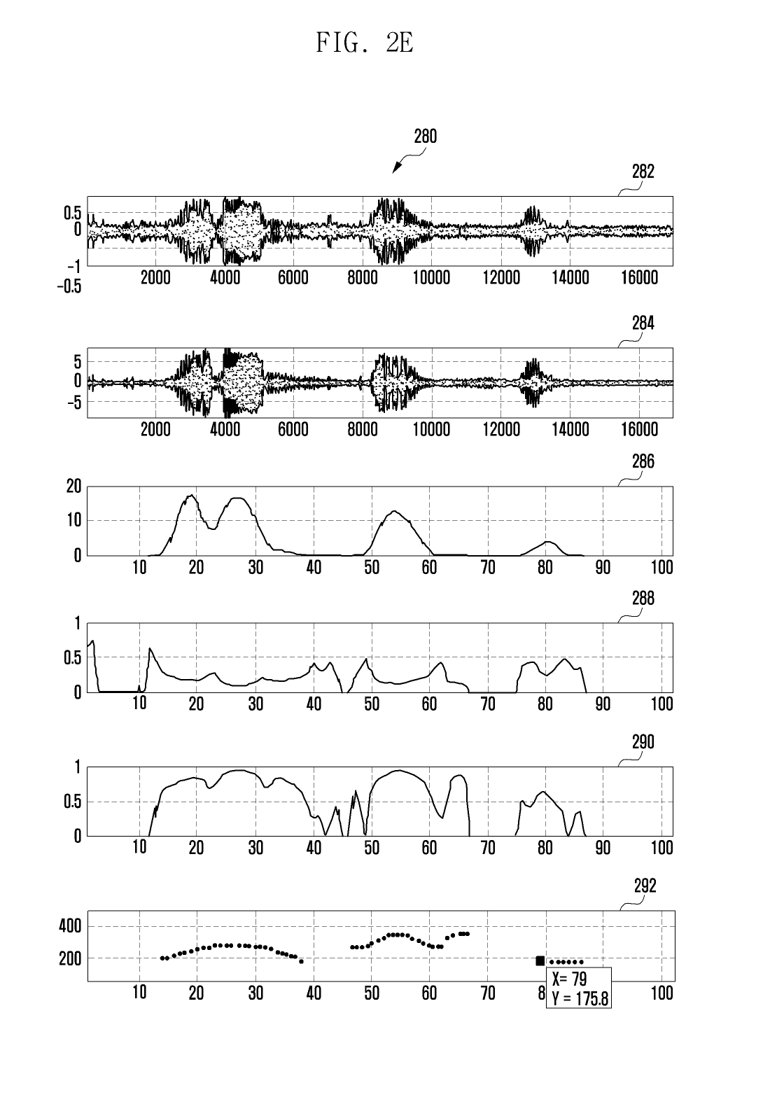

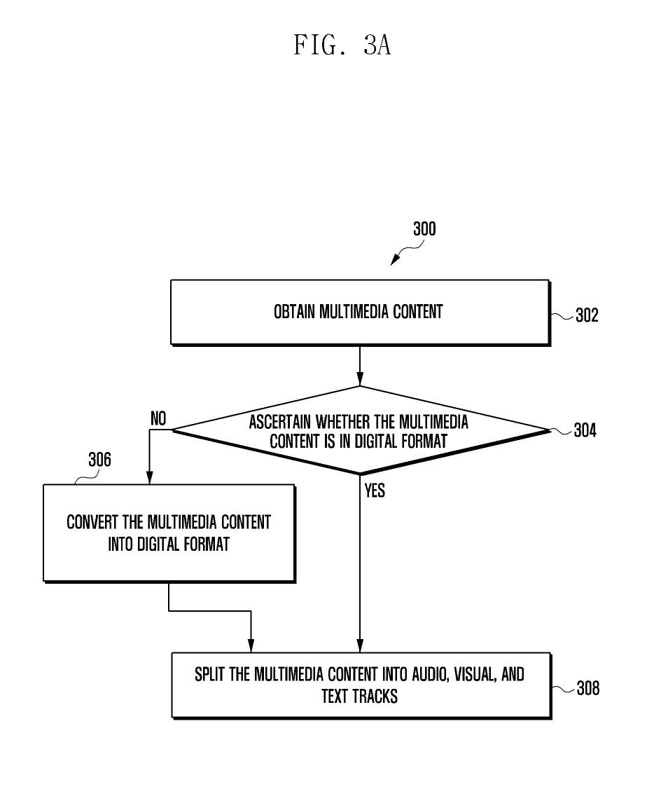

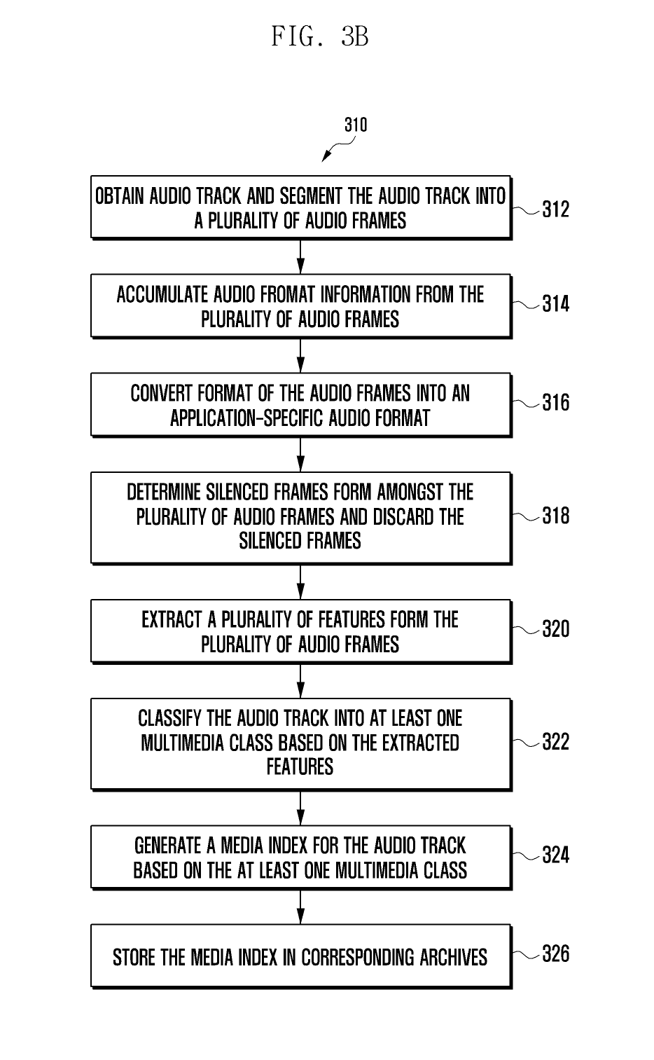

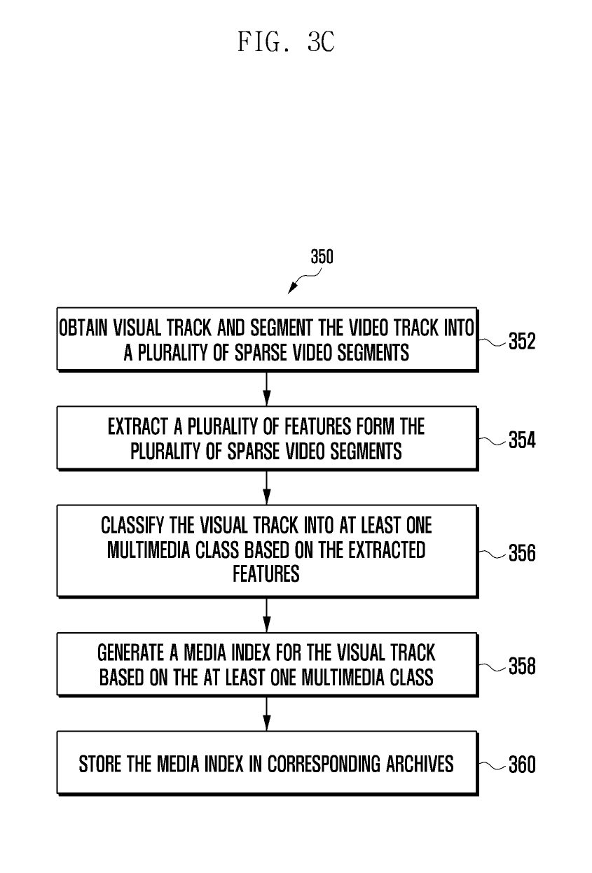

The manner in which the systems and methods shall be implemented has been explained in details with respect to FIG. 1A, FIG. 1B, FIG. 2A, FIG. 2B, FIG. 2C, FIG. 2D, FIG. 2E, FIGS. 3A, 3B, and 3C, FIG. 4, FIG. 5, FIG. 6, and FIG. 7. While aspects of described systems and methods may be implemented in any number of different devices, transmission environments, and/or configurations, the various embodiments are described in the context of the following system(s).

FIG. 1A schematically illustrates a network environment 100 implementing a media accessing system 102 according to an embodiment of the present disclosure.

The media accessing system 102 described herein, may be implemented in any network environment comprising a variety of network devices, including routers, bridges, servers, computing devices, storage devices, etc. In one implementation the media accessing system 102 includes a media classification system 104, connected over a communication network 106 to one or more user devices 108-1, 108-2, 108-3, . . . , 108-N, collectively referred to as user devices 108 and individually referred to as a user device 108.

The network 106 may include Global System for Mobile Communication (GSM) network, Universal Mobile Telecommunications System (UMTS) network, or any of the commonly used public communication networks that use any of the commonly used protocols, for example, Hypertext Transfer Protocol (HTTP) and Transmission Control Protocol/Internet Protocol (TCP/IP).

The media classification system 104 may be implemented in various commercially available computing systems, such as desktop computers, workstations, and servers. The user devices 108 may be, for example, mobile phones, smart phones, tablets, home theatre system, set-top box, IP TVs, and smart TVs and/or conventional computing devices, such as PDAs, and laptops. In one implementation, the user device 108 may generate a mixed reality multimedia interface 110 to facilitate a user to communicate with the media classification system 104 over the network 106.

In one implementation, the network environment 100 comprises a database server 112 communicatively coupled to the media classification system 104 over the network 106. Further, the database server 112 may be communicatively coupled to one or more media source devices 114-1, 114-2, . . . , 114-N, collectively referred to as the media source devices 114 and individually referred to as the media source device 114, over the network 106. The media source devices 114 may be broadcasting media, such as television, radio and internet. In one example, the media classification system 104 fetches multimedia content from the media source devices 114 and stores the same in the database server 112.

In one implementation, the media classification system 104 fetches the multimedia content from the database server 112. In another implementation, the media classification system 104 may obtain multimedia content as a live multimedia stream from the media source device 114 directly over the network 106. The live multimedia stream may be understood to be multimedia content related to an activity which is in progress, such as a sporting event, and a musical concert.

The media classification system 104 initializes processing of the multimedia content. The media classification system 104 splits the multimedia content into its constituent tracks, such as audio track, visual track, and text track. Subsequent to splitting, a plurality of features is extracted from the audio track, visual track, and text track. Further, the media classification system 104 may classify the multimedia content into one or more multimedia classes M₁, M₂, . . . , M_{N}. The multimedia content may be classified into one or more multimedia classes based on the extracted features. The multimedia classes may include comedy, action, drama, family, music, adventure, and horror. Based on the one or more multimedia classes, the media classification system 104 may create a media index for the multimedia content.

A user may input a query to the media classification system 104 through the mixed reality multimedia interface 110 seeking access to the multimedia content of his choice. For example, the user may wish to view live performances of his favorite singer. The multimedia content may be associated with various tags or keywords to facilitate the user to search and view the content of his choice. In response to the user's query, the media classification system 104 may return a list of relevant multimedia content for the user by executing the query on the media index and transmit the same to the user device 108 for being displayed to the user through the mixed reality multimedia interface 110. The user may select the content which he wants to view through the mixed reality multimedia interface 110. For example, the user may select the content by a click on the mixed reality multimedia interface 110 of the user device 108.

Further, the user may have to be authenticated and authorized to access the multimedia content. The media classification system 104 may authenticate the user to access the multimedia content. The user may provide authentication details, such as a passphrase for security and a Personal Identification Number (PIN), to the media classification system 104. The user may be a primary user or a secondary user. Once the media classification system 104 validates the authenticity of the primary user, the primary user is prompted to access the multimedia content through the mixed reality multimedia interface 110. The primary user may have to grant permissions to the secondary users to access the multimedia content. In one implementation, the primary user may prevent the secondary users from viewing content of some multimedia classes. The restriction on viewing the multimedia content is based on the credentials of the secondary user. For example, the head of the family may be a primary user and the child may be a secondary user. Therefore, the child might be prevented from watching violent scenes.

In an example, the primary and the secondary users may be mobile phone users and may access the multimedia content from a remote server or through a smart IP TV server. In the said example, on one hand, the primary user may access the multimedia content directly from the smart TV or mobile storage and on the other hand, the secondary user may access the multimedia content from the smart IP TV through the remote server, from a mobile device. Further, the primary users and the secondary users may simultaneously access and view the multimedia content. The mixed reality multimedia interface 110 may be secured and interactive and only authorized users are allowed to access the multimedia content. The mixed reality multimedia interface 110 outlook for both the primary users and the secondary users may be similar.

FIG. 1B schematically illustrates components of a media classification system 104 according to an embodiment of the present disclosure.

In one implementation, the media classification system 104 may obtain multimedia content from a media source 122. The media source 122 may be third party media streaming portals and television broadcasts. Further, the multimedia content may include scripted or unscripted audio, visual, and textual track. In an implementation, the media classification system 104 may obtain multimedia content as a live multimedia stream or a stored multimedia stream from the media source 122 directly over a network. The audio track, interchangeably referred to as audio, may include music and speech.

Further, according to an implementation, the media classification system 104 may include a video categorizer 124. The video categorizer 124 may extract a plurality of visual features from the visual track of the multimedia content. In one implementation, the visual features may be extracted from 10 minutes of live streaming or stored visual track. The video categorizer 124 then analyzes the visual features for detecting user specified semantic events, hereinafter referred to as key video events, present in the visual track. The key video events may be, for example, comedy, action, drama, family, adventure, and horror. In an implementation, video categorizer 124 may use a sparse representation technique for categorizing the visual track videos by automatically training over-complete dictionary using visual features extracted for pre-determined duration of visual track.

The media classification system 104 further includes an index generator 126 for generating a video index based on key video events. For example, a part of the video index may indicate that the multimedia content is “action” for duration of 1:05-4:15 minutes. In another example, a part of the video index may indicate that the multimedia content is “comedy” for duration of 4:15-8:39 minutes. The video summarizer 128 then extracts the main scenes, or objects in the visual track based on the video index to provide a synopsis to a user.

Similarly, the media classification system 104 processes the audio track for generating an audio index. The audio index generator 130 creates the audio index based on key audio events, such as applause, laughter, and cheer. In an example, an entry in the audio index may indicate that the audio track is “comedy” for duration of 4:15-8:39 minutes. Further, the semantic categorizer 132 defines the audio track into different categories based on the audio index. As indicated earlier, the audio track may include speech and music. The speech detector 134 detects speech from the audio track and context based classifier 136 generates a speech catalog index based on classification of the speech from the audio track.

The media classification further includes a music genre cataloger 138 to classify the music and a similarity pattern identifier 140 to generate a music genre based on identifying the similar patterns of the classified music using a sparse representation technique. In an implementation, the video index, audio index, speech catalog index, and music genre may be stored in a multimedia content storage unit 142. The access to the multimedia content stored in the multimedia content storage unit 142 is allowed to an authenticated and an authorized user.

The Digital Rights Management (DRM) unit 144 may secure the multimedia content based on a sparse representation/coding technique and a compressive sensing technique. Further the DRM unit 144 may be an internet DRM unit or a mobile DRM unit. In one implementation, the mobile DRM unit may be present outside the DRM unit 144. In an example, the internet DRM unit may be used for sharing online digital contents such as mp3 music, mpeg videos, etc., and the mobile DRM utilizes hardware of a user device 108 and different third party security license providers to deliver the multimedia content securely.

Once the indices are created, a user may send a query to the user device 108 to access to multimedia content stored in the multimedia content storage unit 142 of the media classification system 104. The multimedia content may be associated with various tags or keywords to facilitate the user to search and view the content of his choice. In an implementation, the user device 108 includes mixed reality multimedia interface 110 and one or more device processor(s) 146. The device processor(s) 146 may be implemented as one or more microprocessors, microcomputers, microcontrollers, digital signal processors, central processing units, state machines, logic circuitries, and/or any devices that manipulate signals based on operational instructions. Among other capabilities, the device processor(s) 146 is configured to fetch and execute computer-readable instructions stored in a memory.

The mixed reality multimedia interface 110 of the user device 108 is configured to receive the query to extract, play, store, and share the accessing the multimedia content of the multimedia class. For example, the user may wish to view all action scenes of a movie released in past 2 months. In an implementation, the user may send the query through a network 106. The mixed reality multimedia interface 110 includes at least one of a touch, a voice, and optical light control application icons to receive the user query.

Upon receiving the user query, the mixed reality multimedia interface 110 is configured to retrieve tagged portion of the multimedia content tagged with the multimedia class by executing the query on the media index. The tagged portion of the multimedia content may be understood as a list of relevant multimedia content for the user. In one implementation, the mixed reality multimedia interface 110 is configured to retrieve the tagged portion of the multimedia content from the media classification system 104. Further, the mixed reality multimedia interface 110 is configured to transmit the tagged portion of the multimedia content to the user. The user may then select the content which he wants to view.

FIG. 2A schematically illustrates the components of the media classification system 104 according to an embodiment of the present disclosure.

In an implementation, the media classification system 104 includes communication interface(s) 204 and one or more processor(s) 206. The communication interfaces 204 may include a variety of commercially available interfaces, for example, interfaces for peripheral device(s), such as data input output devices, referred to as I/O devices, storage devices, network devices, etc. The I/O device(s) may include Universal Serial Bus (USB) ports, Ethernet ports, host bus adaptors, etc., and their corresponding device drivers. The communication interfaces 204 facilitate the communication of the media classification system 104 with various communication and computing devices and various communication networks, such as networks that use a variety of protocols, for example, HTTP and TCP/IP. The processor 206 may be functionally and structurally similar to the device processor(s) 146.

The media classification system 104 further includes a memory 208 communicatively coupled to the processor 206. The memory 208 may include any non-transitory computer-readable medium known in the art including, for example, volatile memory, such as Static Random Access Memory (SRAM), and Dynamic Random Access Memory (DRAM), and/or non-volatile memory, such as Read Only Memory (ROM), erasable programmable ROM, flash memories, hard disks, optical disks, and magnetic tapes.

Further, the media classification system 104, interchangeably referred to as system 104, may include module(s) 210 and data 212. The modules 210 coupled to the processors 206. The modules 210, amongst other things, include routines, programs, objects, components, data structures, etc., which perform particular tasks or implement particular abstract data types. The modules 210 may also be implemented as, signal processor(s), state machine(s), logic circuitries, and/or any other device or component that manipulate signals based on operational instructions. Further, the modules 210 may be implemented in hardware, computer-readable instructions executed by a processing unit, or by a combination thereof.

In one example, the modules 210 further include a segmentation module 214, a classification module 216, a Sparse Coding Based (SCB) skimming module 222, a DRM module 224, a Quality of Service (QoS) module 226, and other module(s) 228. In one implementation, the classification module 216 may further include a categorization module 218 and an index generation module 220. The other modules 228 may include programs or coded instructions that supplement applications or functions performed by the media classification system 104,

The data 212 serves, amongst other things, as a repository for storing data processed, received, and generated by one or more of the modules 210. The data 212 includes multimedia data 230, index data 232 and other data 234. The other data 234 may include data generated or saved by the modules 210.

In operation, the segmentation module 214 is configured to obtain a multimedia content, for example, multimedia files and multimedia streams, and temporarily store the same as the multimedia data 230 in the media classification system 104 for further processing. The multimedia stream may either be scripted or unscripted. The scripted multimedia stream, such as live football match, and TV shows, is a multimedia stream that has semantic structures, such as timed commercial breaks, half-time or extra-time breaks. On the other hand, the unscripted multimedia stream, such as videos on a third party multimedia content streaming portal, is a multimedia stream that is a continuous stream with no semantic structures or a plot.

The segmentation module 214 may pre-process the obtained multimedia content which is in an analog format, to a digital format to reduce computational load during further processing. The segmentation module 214 then splits the multimedia content to extract an audio track, a visual track, and a text track. The text track may be indicative of subtitles. In one implementation, the segmentation module 214 may be configured to compress the extracted visual and audio tracks. In an example, the extracted visual and audio tracks may be compressed in case when channel bandwidth and memory space is not sufficient. The compressing may be performed using sparse coding based decomposition with composite analytical dictionaries. For compressing, the segmentation module 214 may be configured to determine significant sparse coefficients and non-significant sparse coefficients from the extracted visual and audio tracks. Further, the segmentation module 214 may be configured to quantize the significant sparse coefficients and store indices of the significant sparse coefficients.

The segmentation module 214 may then be configured to encode the quantized significant sparse coefficients and form a map of binary bits, hereinafter referred to as binary map. In an example the binary map of visual images in the visual tracks may be formed. The binary map may be compressed by the segmentation module 214 using a run-length coding technique. Further, the segmentation module 214 may be configured to determine optimal thresholds by maximizing compression ratio and minimization distortion, and the quality of the compressed multimedia content may be assessed.

In one example, the segmentation module 214 may analyze the audio track, which includes semantic primitives, such as silence, speech, and music, to detect segment boundaries and generate a plurality of audio frames. Further, the segmentation module 214 may be configured to accumulate audio format information from the plurality of audio frames. The audio format information may include sampling rate (samples per second), number of channels (mono or stereo), and sample resolution (bit/resolution).

The segmentation module 214 may then be configured to convert the format of the audio frames into an application-specific audio format. The conversion of the format of the audio frames may include resampling of the audio frames, interchangeably used as audio signals, at a predetermined sampling rate, which may be fixed as 16000 samples per second. The resampling process may reduce the power consumption, computational complexity and memory space requirements.

In some cases, the plurality of audio frames may also include silenced frames. The silenced frames are the audio frames without any sound. The segmentation module 214 may perform silence detection to identify silenced frames from amongst the plurality of audio frames and filters or discards the silenced frames from subsequent analysis.

In one example, the segmentation module 214 computes short term energy level (En) of each of the audio frames and compares the computed short term energy (En) to a predefined energy threshold (En_{Th}) for discarding the silenced frames. The audio frames having the short term energy level (En) less than the energy threshold (En_{Th}) are rejected as the silenced frames. For example, if the total number of audio frames is 7315, the energy threshold (En_{Th}) is 1.2 and the number of filtered audio frames with short term energy level (En) less than 1.2 is 700, then the 700 audio frames are rejected as silenced frames from amongst the 7312 audio frames. The energy threshold parameter is estimated energy envelogram of the audio signal-block. In an implementation, low frame energy rate is used to identify silenced audio signal by determining statistics of short term energies and performing energy thresholding.

In one implementation, the segmentation module 214 may segment the visual track into a plurality of sparse video segments. The visual track may be segmented into the plurality of sparse video segments based on sparse clustering based features. A sparse video segment may be indicative of a salient image/visual content of a scene or a shot of the visual track. The segmentation module 214 then compares the sparse video segment with one another to identify and discard redundant sparse video segments. The redundant sparse video segments are the video segments which are identical or nearly same as other video segments. In one example, the segmentation module 214 identifies redundant sparse video segments based on various segment features, such as, color histogram, shape, texture, motion vectors, edges, and camera activity.

In one implementation, the multimedia content thus obtained is provided as an input to the classification module 216. The multimedia content may be fetched from media source devices, such as broadcasting media that includes television, radio, and internet. The classification module 216 is configured to extract features from the multimedia content, categorize the multimedia content into one or more multimedia class based on the extracted features, and then create a media index for the multimedia content based on the at least one multimedia class.

In an implementation, the categorization module 218 extracts a plurality of features from the multimedia content. The plurality of features may be extracted for detecting user specified semantic events expected in the multimedia content. The extracted features may include key audio features, key video features, and key text features. Examples of key audio features may include songs, music of different multimedia categories, speech with music, applause, wedding ceremonies, educational videos, cheer, laughter, sounds of a car-crash, sounds of engines of race cars indicating car-racing, gun-shots, siren, explosion, and noise.

The categorization module 218 may implement techniques, such as optical character recognition techniques, to extract key text features from subtitles and text characters on the visual track or the key video features of the multimedia content. The key text features may be extracted using a level-set based character and text portion segmentation technique. In one example, the categorization module 218 may identify key text features, including meta-data, text on video frames such as board signs and subtitle text, based on N-gram model, which involves determining of key textual words from an extracted sequence of text and analyzing of a contiguous sequence of n alphabets or words. In an implementation, the categorization module 218 may use a sparse text mining method for searching high-level semantic portions in a visual image. In the said implementation, the categorization module 218 may use the sparse text mining on the visual image by performing level-set and non-linear diffusion based segmentation and sparse coding of text-image segments.

In one implementation, the categorization module 218 may be configured to extract the plurality of key audio features based on one or more of temporal-spectral features including energy ratio, Low Energy Ratio (LER) rate, Zero Crossing Rate (ZCR), High Zero Crossing Rate (HZCR), periodicity and Band Periodicity (BP) and short-time, Fourier transform features including spectral brightness, spectral flatness, spectral roll-off, spectral flux, spectral centroid, and spectral band energy ratios, signal decomposition features, such as wavelet sub band energy ratios, wavelet entropies, Principal Component Analysis (PCA), Independent Component Analysis (ICA) and Non-negative Matrix Factorization (NMF), statistical and information-theoretic features including variance, skewness and kurtosis, information, entropy, and information divergence, acoustic features including Mel-Frequency Cepstral Coefficients (MFCC), Linear Predictive Coding (LPC), Liner Prediction Cepstral Coefficient (LPCC), and Perceptual Linear Predictive (PLP), and sparse representation features.

Further, the categorization module 218 may be configured to extract key visual features may be based on static and dynamic features, such as color histograms, color moments, color correlograms, shapes, object motions, camera motions and texture, temporal and spatial edge lines, Gabor filters, moment invariants, PCA, Scale Invariant Feature Transform (SIFT), and Speeded Up Robust Features (SURF) features. In an implementation, the categorization module 218 may be configured to determine a set of representative feature extraction methods based upon receipt of user selected multimedia content categories and key scenes.

In one implementation, the categorization module 218 may be configured to segment the visual track using an image segmentation method. Based on the image segmentation method, the categorization module 218 classifies each visual image frame as a foreground image having the objects, textures, or edges, or a background image frame having no textures or edges. Further, the image segmentation method may be based on non-linear diffusion, local and global thresholding, total variation filtering, and color-space conversion models for segmenting input visual image frame into local foreground and background sub-frames.

Furthermore, in an implementation, the categorization module 218 may be configured to determine objects using local and global features of visual image sequence. In the said implementation, the objects may be determined using a partial differential equation based on parametric and level-set methods.

According to an implementation, the categorization module 218 may be configured to exploit the sparse representation of key text features of the determined for detecting key objects. Furthermore, connected component analysis is utilized under low-resolution visual image sequence condition and a sparse recovery based super-resolution method is adapted for the enhancing quality of visual images.

The categorization module 218 may further categorize or classify the multimedia content into at least one multimedia class based on the extracted features. For example, a 10 minute of live or stored multimedia content may be analyzed by the categorization module 218 to categorize the multimedia content into at least one multimedia class based on the extracted features. The classification is based on an information fusion technique. The fusion techniques may involve weighted sum of the similarity scores. Based on the information fusion technique, combined matching scores are obtained from the similarity scores obtained for all test models of the multimedia content.

In an example, the classes of the multimedia content may include comedy, action, drama, family, adventure, and horror. Therefore, if the key video features, such as car-crashing, gun-shots, and explosion, are extracted, then the multimedia content may be classified into the “action” of the multimedia content class. In another example, based the key audio features such as laughter, and cheer, the multimedia content may be classified into the “comedy” class of the multimedia content class. In one implementation, the categorization module 218 may be configured to cluster the at least one multimedia content class. For example, the multimedia content classes, such as “action”, “comedy”, “romantic”, and “horror” may be clustered together as one class “movies”. In another implementation, the categorization module 218 may not cluster the at least one multimedia content class.

In one implementation, the categorization module 218 may be configured to classify the multimedia content using sparse coding of acoustic features extracted in both time-domain and transform domain, compressive sparse classifier, Gaussian mixture models, information fusion technique, and sparse-theoretic metrics, in case the multimedia content includes audio track.

In one implementation, the segmentation module 214 and the categorization module 218 module may be configured to perform segmentation and classification of the audio track using a sparse signal representation, a sparse coding technique, or a sparse recovery techniques in a learned composite dictionary matrix containing concatenation of analytical elementary atoms or functions from the impulse, Heaviside, Fourier bases, short-time Fourier transform, discrete cosines and sines, Hadamard-Walsh functions, pulse functions, triangular functions, Gaussian functions, Gaussian derivatives, sinc functions, Haar, wavelets, wavelet packets, Gabor filters, curvelets, ridgelets, contourlets, bandelets, shearlets, directionlets, grouplets, chirplets, cubic polynomials, spline polynomials, Hermite polynomials, Legendre polynomials, and any other mathematical functions and curves.

For example, let L represent the number of key audios, and P represent the number of trained audio frames for each key audio. Using the sparse representations, the m^{th} audio data of the l^{th} key audio is expressed as:

Sₘ^{(l)}=ψₘ^{(l)}αₘ^{(l)} Equation (1)

where Ψₘ^{(l)} denotes the trained sub-dictionary created for p^{th} audio frame from the l^{th} key audio, and

αₘ^{(l)} denotes coefficient vector obtained for the p^{th} audio frame during testing phase using sparse recovery or sparse coding techniques in complete dictionaries form the key audio template database. The trained sub-dictionary created by the categorization module 218 for the l^{th} key audio is given by:

ψₚ^{(l)}=└ψ_{p,1}^{(l)},ψ_{p,2}^{(l)},ψ_{p,3}, . . . ,ψ_{p,N}^{(l)}┘ Equation (2)

For example, the key audio template composite signal dictionary containing concatenation of key-audio specific information from all the key audios for representation may be expressed as:

B^{CS}=└|ψ₁⁽¹⁾,ψ₂⁽¹⁾, . . . ,ψ_{P}^{(l)}|ψ₁⁽²⁾,ψ₂⁽²⁾, . . . ,ψ_{P}⁽²⁾| . . . |ψ₁^{(L)},ψ₂^{(L)}, . . . ,ψ_{P}^{(L)}|┘ Equation (3)

The aforementioned equation may be rewritten as:

B^{CS}=[ψ₁,ψ₂,ψ₃, . . . ,ψ_{L×p×N}] Equation (4)

Further, the key audio template dictionary database B generated by the categorization module 218 may include a variety of elementary atoms and may be denoted as:

B=└B^{ca}|B^{cs}|B^{cf}┘ Equation (5)

where
ca represents composite analytical waveforms,
cs represents composite raw signal and image components, and
cf represents composite signal and image features.

The input audio frame may be represented as a linear combination of the elementary atom vectors from the key audio template. For example, the input audio frame may be approximated in the composite analytical dictionary as:

$$x = {\sum }_{i = 1}^{L \times P \times N} {α}_{i} {ψ}_{i} = B α \qquad Equation ( 6 )$$

where α=α₁, α₂, . . . , α_{L×P×N}.

The sparse recovery is computed by solving convex optimization problem that may result in a sparse coefficient vector when the B satisfies properties and has enough collection of elementary atoms that may lead to sparsest solution. The sparsest coefficient vector α may be obtained by solving the following optimization problem:

$$\hat{α} = arg {min}_{α} {‖ α ‖}_{1} subjectto x = B α \qquad Equation ( 7 )$$

where ∥Ψα−x∥₂² and ∥α∥₁ are known as the fidelity term and the sparsity term, respectively,

x is the signal to be decomposed, and

λ is a regularization parameter that controls the relative importance of the fidelity and sparseness terms.

The l₁-norm and l₂-norm of the vector α are defined as ∥α∥ₗ_{₁}=Σᵢ|αᵢ| and ∥α∥ₗ_{₂}=(Σᵢ|αᵢ|²)^{1/2}, respectively. The above convex optimization problem may be solved by linear programming, such as Basis Pursuit (BP) or non-linear iterative greedy algorithms, such as Matching Pursuit (MP), and Orthogonal Matching Pursuit (OMP).

In such signal representations, the input audio frame may be exactly represented or approximated by the linear combination of a few elementary atoms that are highly coherent with the input key audio frame. According to the sparse representations, the elementary atoms which are highly coherent with input audio frame have large amplitude value of coefficients. By processing the resulting sparse coefficient vectors, the key audio frame may be identified by mapping the high correlation sparse coefficients with their corresponding audio class in the key audio frame database. The elementary atoms which are not coherent with the input audio frame may have smaller amplitude values of coefficients in the sparse coefficient vector α.

In one implementation, the categorization module 218 may also be configured to cluster the multimedia classes. The clustering may be based on determining sparse coefficient distance. The multimedia classes may include different types of audio and visual events. As indicated earlier, the categorization module 218 may be configured to classify the multimedia content into at least one multimedia class based on the extracted features. In one example, the multimedia content may be bookmarked by a user. The audio and the visual content may be clustered based on analyzing sparse co-efficient parameters and sparse information fusion method. The multimedia content may be enhanced and noise components may be suppressed by a media controlled filtering technique.

In one implementation, the categorization module 218 may be configured to suppress noise components from the constituent tracks of the multimedia content based on a media controlled filtering technique. The constituent tracks include a visual track and an audio track. Further, the categorization module 218 may be configured to segment the visual track and the audio track into a plurality of sparse video segments and a plurality of audio segments, respectively and a plurality of highly correlated segments from amongst the plurality of sparse video segments and the plurality of audio segments may be identified.

Further, the categorization module 218 may be configured to determine a sparse coefficient distance based on the plurality of highly correlated segments and cluster the plurality of sparse video segments and the plurality of audio segments based on the sparse coefficient distance.

Subsequent to classification, the index generation module 220 is configured to create a media index for the multimedia content based on the at least one multimedia class. For example, a part of the media index may indicate that the multimedia content is “action” for duration of 1:05-4:15 minutes. In another example, a part of the media index may indicate that the multimedia content is “comedy” for duration of 4:15-8:39 minutes. In an implementation, the index generation module 220 is configured to associate multi-lingual dictionary meaning for the created media index of the multimedia content based on user request. In an example, the multimedia content may be classified based on automatic training dictionary using visual sequence extracted for pre-determined duration of the multimedia content. In one implementation, the created media index of the multimedia content may be stored within the index data 232 of the system 104. In an example, the media index may be stored or send to electronic device or cloud servers. In one implementation, the index generation module 220 may be configured to generate a mixed reality multimedia interface to allow users to access the multimedia content. In another implementation, the mixed reality multimedia interface may be provided on a user device 108.

In one implementation, the sparse coding based skimming module 222 is configured to extract low-level features by analyzing the audio track, the visual track and the text track. Examples of the low-level features commercial breaks and boundaries between shots in the visual track. The sparse coding based skimming module 222 may further be configured to determine boundaries between shots using shot detection techniques, such as sum of absolute sparse coefficient differences and event change ratio sparse representation domain.

The sparse coding based skimming module 222 is configured to divide the visual track into a plurality of sparse video segments using the shot detection technique and analyze them to extract high-level features, such as object recognition, highlight object scene, and event detection. The sparse coding of high-level features may be used to determine semantic correlation between the sparse video segments and the entire visual track, for example, based on action, place and time of the scenes depicted in the sparse video segments.

Upon determining, the sparse coding based skimming module 222 may be configured to analyze the sparse video segments using sparse based techniques, such as sparse scene transition vector to detect sub-boundaries. Based on the analysis, the sparse coding based skimming module 222 selects the sparse video segments important for the plot of the multimedia content are selected as key events or key sub-boundaries. Then the sparse coding based skimming module 222 summarizes all the key events to generate a skim for the multimedia content.

In one implementation, the DRM module 224 is configured to secure the multimedia content in index data 232. The multimedia content in the index data 232 may be protected using techniques, such as sparse based digital watermarking, fingerprinting, and compressive sensing based encryption. The DRM module 224 is also configured to manage user access control using a multi-party trust management system. The multi-party trust management system also controls unauthorized user intrusion. Based on digital watermarking technique, a watermark, such as a pseudo noise is added to the multimedia content for identification, sharing, tracing and control of piracy. Therefore, authenticity of the multimedia content is protected and is secured from impeding attacks of illegitimate users, such as mobile users.

Further, the DRM module 224 is configured to create a sparse based watermarked multimedia content using the characteristics of the multimedia content. The created sparse watermark is used for sparse pattern matching of the multimedia content in the index data 232. The DRM module 224 is also configured to control the access to the index data 232 by the users and encrypts the multimedia content using one or more temporal, spectral-band, compressive sensing method, and compressive measurements scrambling techniques. Every user is given a unique identifier, a username, a passphrase, and other user-linkable information to allow them to access the multimedia content.

In one implementation, the watermarking and the encryption may be executed with composite analytical and signal dictionaries. For example, a visual-audio-textual event datastore is arranged to construct a composite analytical and signal dictionaries corresponding to the patterns of multimedia classes for performing sparse representation of audio and visual track.

In the said implementation, the multimedia content may be encrypted by using scrambling sparse coefficients. The fixed/variable frame size and frame rate is used for encrypting user-preferred multimedia content. In a further implementation, the encryption of the multimedia content may be executed by employing scrambling of blocks of samples in both temporal and spectral domains and also scrambling of compressive sensing measurements.

Once the media index is created, a user may send a query to system 104 through a mixed reality multimedia interface 110 of the user device 108 to access to the index data 232. For example, the user may wish to view all action scenes of a movie released in past 2 months. Upon receiving the user query, the system 104 may retrieve a list of relevant multimedia content for the user by executing the query on the media index and transmit the same to the user device 108 for being displayed to the user. The user may then select the content which he wants to view. The system 104 would transmit only the relevant portions of the multimedia content and not the whole file storing the multimedia content, thus saving the bandwidth and download time of the user.

In an implementation, the user may send the query to system 104 to access the multimedia content based on his personal preferences. In an example, the user may access the multimedia content on a smart IP TV or a mobile phone through the mixed reality multimedia interface 110. In the said example, an application of the mixed reality multimedia interface 110 may include a touch, a voice, or an optical light control application icon. The user request may be collected through these icons for extraction, playing, storing, and sharing user specific interesting multimedia content. In a further implementation, the mixed reality multimedia interface 110 may provide provisions to perform multimedia content categorization, indexing and replaying the multimedia content based on user response in terms of voice commands and touch commands using the icons. In an example, the real world and the virtual world multimedia content may be merged together in real time environment to seamlessly produce meaningful video shots of the input multimedia content.

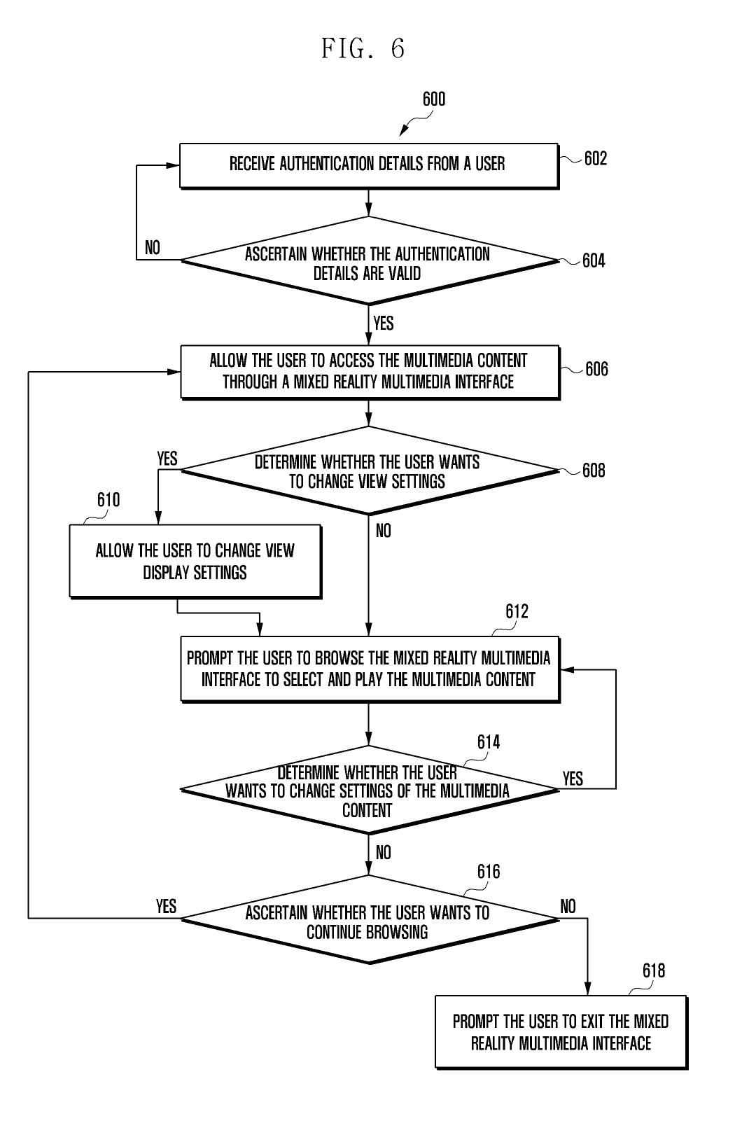

Also the system 104 prompts an authenticated and an authorized user to view, replay, store, share, and transfer the restricted multimedia content. The DRM module 224 may ascertain whether the user is authenticated. Further, the DRM module 224 prevents unauthorized viewing or sharing of multimedia content amongst users. The method for prompting an authenticated user to access the multimedia content has been explained in detail with reference to FIG. 6 subsequently in this document.

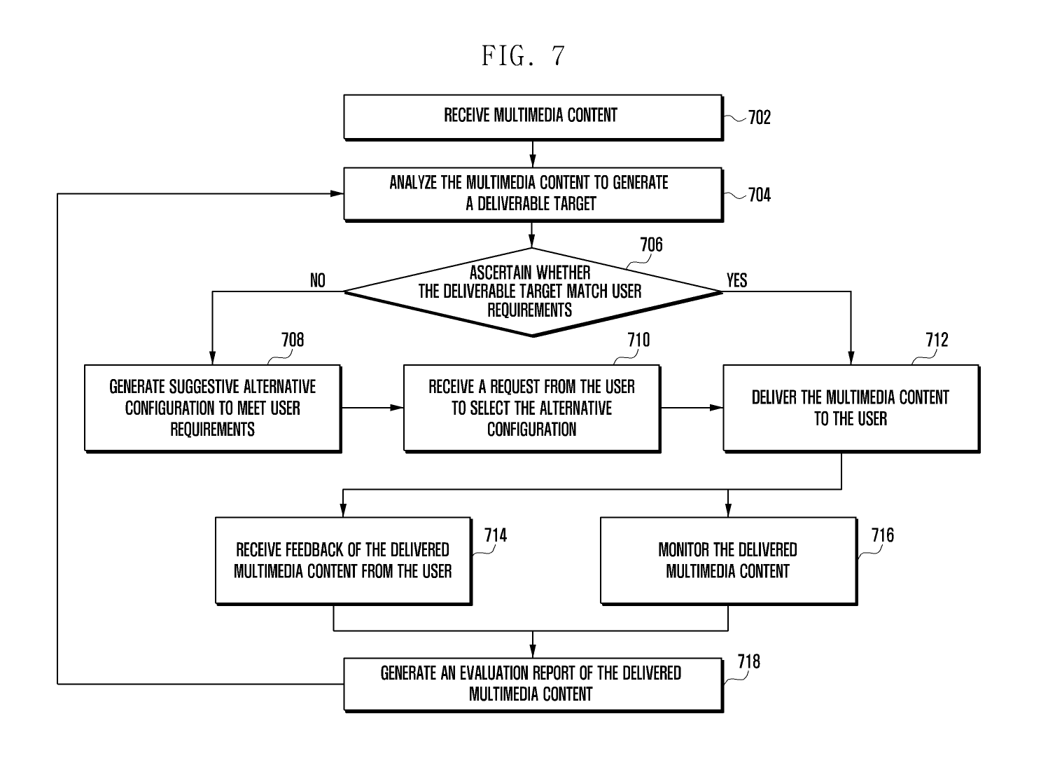

In one implementation, the QoS module 226 is configured to obtain feedback or rating regarding the indexing of the multimedia content from the user. Based on the received feedback, the QoS module 226 is configured to update the media index. Various machine learning languages may be employed by the QoS module 226 to enhance the classification the multimedia content in accordance with the user's demand and satisfaction. The method of obtaining the feedback of the multimedia content from the user has been explained in detail with reference to FIG. 7 subsequently in this document.

FIG. 2B illustrates a decision-tree based sparse sound classification unit 240, hereinafter referred to as unit 240 according to an embodiment of the present disclosure.

Referring to FIG. 2B, multimedia content, depicted by arrow 242, may be obtained from a media source 241, such as third party media streaming portals and television broadcasts. The multimedia content 242 may include, for example, multimedia files and multimedia streams. In an example, the multimedia content 242 may be a broadcasted sports video. The multimedia content 242 may be processed and split be into an audio track and a visual track. The audio track proceeds to an audio sound processor, depicted by arrow 244 and the visual track proceeds to video frame extraction block, depicted by 243.

The audio sound processor 244 includes an audio track segmentation block 245. Here, the audio track is segmented into a plurality of audio frames. Further, audio format information is accumulated from the plurality of audio frames. The audio format information may include sampling rate (samples per second), number of channels (mono or stereo), and sample resolution (bit/resolution). Furthermore, format of the audio frames is converted into an application-specific audio format. The conversion of the format of the audio frames may include resampling of the audio frames, interchangeably used as audio signals, at a predetermined sampling rate, which may be fixed as 16000 samples per second. In an example, the resampling of audio frames may be based upon spectral characteristics of graphical representation of user-preferred key audio sound.

Further, at silence removal block 246, silenced frames are discarded from amongst the plurality of audio frames. The silenced frames may be discarded based upon information related to recording environment. At feature extraction block 247, a plurality of key audio features are extracted based on one or more of temporal-spectral features, Fourier transform features, signal decomposition features, statistical and information-theoretic features, acoustic, and sparse representation features. Further, at classification block 248, the audio track may be classified into at least one multimedia class based on the extracted features. In an example, key audio events may be detected by comparing one or more metrics computed in sparse representation domain. For example, the audio track may be a tennis game and the key audio events may be an applause sound. In another example, the key audio event may be laughter sound.

Also, at classification block 248, intra-frame, inter-frame and inter-channel sparse data correlations of the audio frames may be analyzed for ascertaining the various key audio events for determination. At boundary detection block 249, semantic boundary may be detected from the audio frames. Further, at time instants and audio block 250, time instants of the detected sparse key audio events and audio sound may be determined. The determined time instant may then be used for video frames extraction at video frame extraction block 243. Also, key video events may be determined.

The audio and the video may then be encoded at encoder block 251. The key audio sounds may be compressed by a quality progressive sparse audio-visual compression technique. The significant sparse coefficients and insignificant coefficients may be determined and the significant sparse coefficients may be quantized and encoded quantized sparse coefficients. The data-rate driven sparse representation based compression technique may be used when channel bandwidth and memory space is limited.

At index generation block 252, media index is generated. The media index is generated for the multimedia content based on the at least one multimedia class or key audio or video sounds. Further, at multimedia content archives block 253 the media index generated for the multimedia content is stored in corresponding archives. The archives may include comedy, music, speech, and music plus speech.

An authenticated and an authorized user may then access the multimedia content archives 253 through a search engine 254. The user may access the multimedia content through a user device 108. In an example, a mixed reality multimedia interface 110 may be provided on the user device 108 to access the multimedia content 242. The mixed reality multimedia interface 110 may include a touch, a voice, and an optical light control application icons configured for collecting user requests, powerful digital signal, image and video processing techniques to extract, play, store, and share interesting audio and visual events.

FIG. 2C illustrates a graphical representation 260 depicting performance of an applause sound detection method according to an embodiment of the present disclosure.

The performance of an applause sound detection method is represented by graphical plots 262, 264, 266, 268, 270 and 272. The applause sound is a key audio feature extracted from an audio track, interchangeably referred to as an audio signal. In an example, the audio track may be segmented into a plurality of audio frames before extraction of the applause sound.

The applause sound may be detected based on one or more of temporal features including short-time energy, LER, and ZCR, short-term auto-correlation features including first zero-crossing point, first local minimum value and its time-lag, local maximum value and its time-lag, and decaying energy ratios, feature smoothing with predefined window size, and the hierarchical decision-tree based decision with predetermined thresholds.

The graphical plot 262 depicts an audio signal from a tennis sports video that includes an applause sound portion and a speech sound portion. As indicated in above described example, the audio track or the audio signal may be segmented into a plurality of audio frames. The graphical plot 264 represents a short-term energy envelope of processed audio signal, that is, energy value of each audio frame. The graphical plots 266, 268, 270 and 272 depicts extracted autocorrelation features that are used for detecting the applause sound. The graphical plot 266 depicts decaying energy ratio value of autocorrelation features of each audio frame and the graphical plots 268, 270 and 272 depict maximum peak value, lag value of the maximum peak, and the minimum peak value of autocorrelation features of each audio frame, respectively.

FIG. 2D illustrates a graphical representation 274 depicting feature pattern of an audio track with laughing sounds according to an embodiment of the present disclosure.

In an example, the laughing sound is detected based on determining non-silent audio frames from amongst a plurality of audio frames. Further, from voiced-speech portions of the audio track, event-specific features are extracted for characterizing laughing sounds. Upon extraction of the event-specific features, a classifier is determined for determining similarity between the input signal feature templates with stored feature templates. The laughing sound detection method is based on Mel-scale frequency Cepstral coefficients and autocorrelation features. The laughing sound detection method is further based on sparse coding techniques for distinguishing laughing sounds from the speech, music and other environmental sounds.

The graphical plot 276 represents an audio track including laughing sound. The audio track is digitized with sampling rate of 16000 Hz and 16-bit resolution. The graphical plot 278 depicts a smoothed autocorrelation energy decay factor or decaying energy ratio for the audio track.

FIG. 2E illustrates a graphical representation 280 depicting performance of a voiced-speech pitch detection method according to an embodiment of the present disclosure.

The voiced-speech pitch detection method is based on features of pitch contour obtained for an audio track. Further, the pitch may be tracked based on a Total Variation (TV) filtering, autocorrelation feature set, noise floor estimation from total variation residual, and a decision tree approach. Furthermore, energy and low sample ratio may be computed for discarding silenced audio frames present in the audio track. The TV filtering may be used to perform edge preserving smoothing operation which may enhance high-slopes corresponding to the pitch period peaks in the audio track under different noise types and levels.

The noise floor estimation unit processes TV residual obtained for the speech audio frames. The noise floor estimated in the non-voice portions of the speech audio frames may be consistently maintained by TV filtering. The noise floor estimation from the TV residual provides discrimination of a voice track portion from a non-voice track portion in the audio track under a wide range of background noises. Further, high possibility of pitch doubling and pitch halving errors introduced due to variations of phoneme level and prominent slowly varying wave component between two pitch peaks portions may be prevented by TV filtering. Then, energy of the audio frames are computed and compared with a predetermined threshold. Subsequent to comparison, decaying energy ratio, amplitude of minimum peak and zero crossing rate are computed from the autocorrelation of the total variation filtered audio frames. The pitch is then determined by computing the pitch lag from the autocorrelation of the TV filtered audio track, in which the pitch lags are greater than the predetermined thresholds.

The voiced-speech pitch detection method may be employed using speech audio track under different kinds of environmental sounds including, applause, laughter, fan, air conditioning, computer hardware, car, train, airport, babble, and thermal noise. The graphical plot 282 depicts a speech audio track that includes an applause sound. The speech audio track may be digitized with sampling rate of 16000 Hz and 16-bit resolution.

The graphical plot 284 shows the output of the preferred total variation filtering, that is, filtered audio track. Further, the graphical plot 286 depicts the energy feature pattern of short-time energy feature used for detecting silenced audio frames. The graphical plot 288 represents a decaying energy ratio feature pattern of an autocorrelation decaying energy ratio feature used for detecting voiced speech audio frames and the graphical plot 290 represents a maximum peak feature pattern for detection of voiced speech audio frames. The graphical plot 292 depicts a pitch period pattern. As may be seen from the graphical plots the total variation filter effectively reduces background noises and emphasizes the voiced-speech portions of the audio track.

FIGS. 3A, 3B, and 3C illustrate methods 300, 310, and 350 respectively, for segmenting multimedia content and generating a media index for the multimedia content according to an embodiment of the present disclosure.

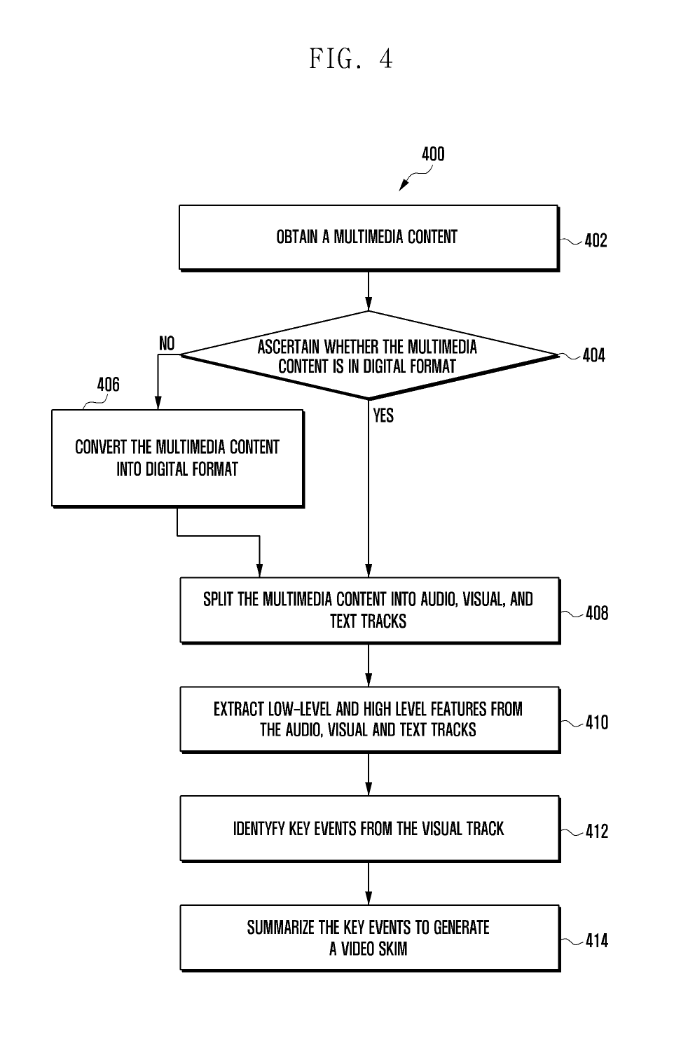

FIG. 4 illustrates a method 400 for skimming the multimedia content according to an embodiment of the present disclosure.

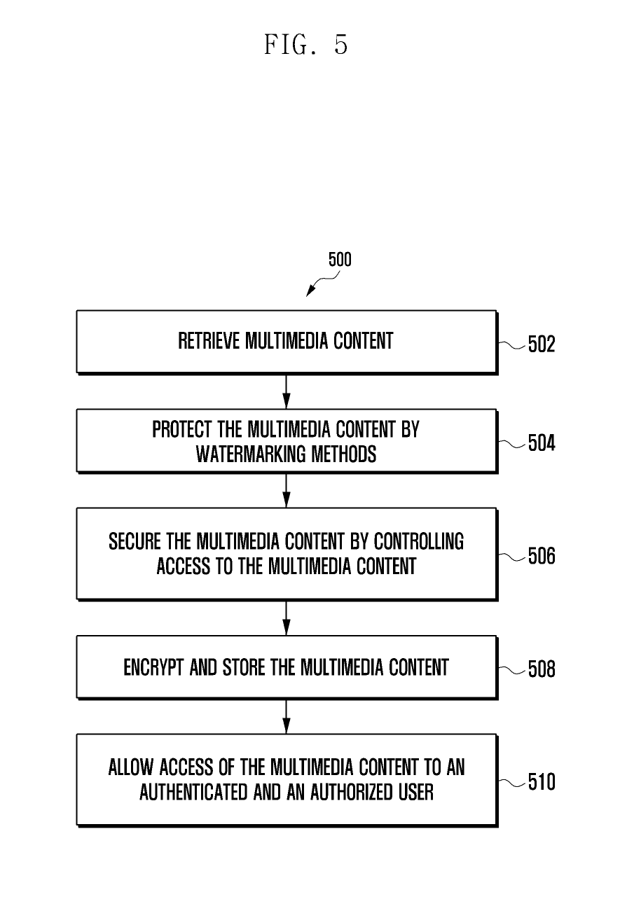

FIG. 5 illustrates a method 500 for protecting the multimedia content from an unauthenticated and an unauthorized user according to an embodiment of the present disclosure.

FIG. 6 illustrates a method 600 for prompting an authenticated user to access the multimedia content according to an embodiment of the present disclosure.

FIG. 7 illustrates a method 700 for obtaining a feedback of the multimedia content from the user, in accordance with user demand according to an embodiment of the present disclosure.

The order in which the methods 300, 310, 350, 400, 500, 600, and 700 are described is not intended to be construed as a limitation, and any number of the described method blocks may be combined in any order to implement the methods, or any alternative methods. Additionally, individual blocks may be deleted from the methods without departing from the spirit and scope of the subject matter described herein. Furthermore, the methods may be implemented in any suitable hardware, software, firmware, or combination thereof.

The steps of the methods 300, 310, 350, 400, 500, 600, and 700 may be performed by programmed computers and communication devices. Herein, some various embodiments are also intended to cover program storage devices, for example, digital data storage media, which are machine or computer readable and encode machine-executable or computer-executable programs of instructions, where said instructions perform some or all of the steps of the described methods. The program storage devices may be, for example, digital memories, magnetic storage media, such as a magnetic disks and magnetic tapes, hard drives, or optically readable digital data storage media. The various embodiments are also intended to cover both communication network and communication devices configured to perform said steps of the exemplary methods.

Referring to the FIG. 3A, at block 302 of the method 300, multimedia content is obtained from various sources. In an example, the multimedia content may be fetched by the segmentation module 214 from various media sources, such as third party media streaming portals and television broadcasts.

At block 304 of the method 300, it is ascertained whether the multimedia content is in a digital format. In an implementation, segmentation module 214 may determine whether the multimedia content is in digital format. If it is determined that the multimedia content is not in digital format, i.e., it is in an analog format, the method 300 proceeds to block 306 (‘No’ branch). As depicted in block 306, the multimedia content is converted into the digital format and then method 300 proceeds to block 308. In one implementation, the segmentation module 214 may use an analog to digital converter to convert the multimedia content into the digital format.

However, if at block 304, it is determined that the multimedia content is in digital format, the method 300 proceeds to block 308 (‘Yes’ branch). As illustrated in block 308, the multimedia content is then split into its constituent tracks, such as an audio track, a visual track, and a text track. For example, the segmentation module 214 may split the multimedia content into its constituent tracks based on techniques, such as decoding and de-multiplexing.

Referring to FIG. 3B, at block 312 of the method 310, the audio track is obtained and segmented into a plurality of audio frames. In an implementation, the segmentation module 214 segments the audio track into a plurality of audio frames.

At block 314 of the method 310, audio format information is accumulated from the plurality of audio frames. The audio format information may include sampling rate (samples per second), number of channels (mono or stereo), and sample resolution (bit/resolution). In one implementation, the segmentation module 214 accumulates audio format information from the plurality of audio frames.

At block 316 of the method 310, format of the audio frames is converted into an application-specific audio format. The conversion of the format of the audio frames may include resampling of the audio frames, interchangeably referred to as audio signals, at predetermined sampling rate, which may be fixed as 16000 samples per second. The resampling process may reduce the power consumption, computational complexity and memory space requirements. In one implementation, the segmentation module 214 converts the format of the audio frames into an application-specific audio format.

As depicted in block 318, the silenced frames are determined from amongst the plurality of audio frames and discarded. The silenced frames may be determined using low-energy ratios and parameters of energy envelogram. In one example, the segmentation module 214 performs silence detection to identify silenced frames from amongst the plurality of audio frames and discard the silenced frames from subsequent analysis.

At block 320 of the method 310, a plurality of features is extracted from the plurality of audio frames. The plurality of features may include key audio features, such as songs, speech with music, music, sound, and noise. In an implementation, the categorization module 218 extracts a plurality of features from the audio frames.

At block 322 of the method 310, the audio track is classified into at least one multimedia class based on the extracted features. The multimedia class may include any one of classes such as silence, speech, music (classical, jazz, metal, pop, rock and so on), song, speech with music, applause, cheer, laughter, car-crash, car-racing, gun-shot, siren, plane, helicopter, scooter, raining, explosion and noise. In an example, based the key audio features, such as laughter, and cheer, the audio track may be classified as “comedy”, a multimedia class. In one configuration, the categorization module 218 may classify the audio track into at least one multimedia class.

At block 324 of the method 310, a media index is generated for the audio track based on the at least one multimedia class. In an example, an entry in the media index may indicate that the audio track is “comedy” for duration of 4:15-8:39 minutes. In one implementation, the index generation module 220 may generate the media index for the audio track based on the at least one multimedia class.

At block 326, the media index generated for the audio track is stored in corresponding archives. The archives may include comedy, music, speech, music plus speech and the like. In the example, the media index generated for the audio track may be stored in the index data 232.

Referring to FIG. 3C, at block 352 of the method 350, the visual track is obtained and segmented into a plurality of sparse video segments. In an implementation, the segmentation module 214 segments the visual track into a plurality of sparse video segments based on sparse clustering based features.

As depicted in block 354 of the method 350, a plurality of features is extracted from the plurality of sparse video segments. The plurality of features may include key video features, such as gun-shots, siren, and explosion. In an implementation, the categorization module 218 extracts a plurality of features from the sparse video segments.

At block 356 of the method 350, the visual track is classified into at least one multimedia class based on the extracted features. In an example, based the key video features, such as gun-shots, siren, and explosion, the visual track may be classified into an “action” class of the multimedia class. In one example, the categorization module 218 may classify the video content into at least one multimedia class.

At block 358 of the method 350, a media index is generated for the visual track based on at the least one multimedia class. In an example, an entry of the media index may indicate that the visual track is “action” for duration of 1:15-3:05 minutes. In one implementation, the index generation module 220 may generate the media index for the visual track based on the at least one multimedia class.

At block 360 of the method 350, the media index generated for the visual track is stored in corresponding archives. The archives may include action, adventure, and drama. In the example, the media index generated for the visual track may be stored in the index data 232.

Referring to FIG. 4, at block 402 of the method 400, the multimedia content is obtained from various media sources. In an example, the multimedia content may be obtained by the sparse coding based skimming module 222.

At block 404 of the method 400, it is ascertained whether the multimedia content is in a digital format. In an implementation, sparse coding based skimming module 222 may determine whether the multimedia content is in digital format. If it is determined that the multimedia content is not in a digital format, the method 400 proceeds to block 406 (‘No’ branch). At block 406, the multimedia content is converted into the digital format and then method 400 proceeds to block 408.

However, if at block 404, it is determined that the multimedia content is in digital format, the method 400 straightaway proceeds to block 408 (‘Yes’ branch). At block 408 of the method 400, the multimedia content is split into an audio track, a visual track and a text track. In an example, the sparse coding based skimming module 222 may split the multimedia content based on techniques, such as decoding and de-multiplexing.

At block 410 of the method 400, low-level and high-level features are extracted from the audio track, the visual track, and the text track. Examples of low-level and high level features include commercial breaks and boundaries between the shots. In one implementation, the sparse coding based skimming module 222 may extract low-level and high-level features from the audio track, the visual track and the text track using shot detection techniques, such as sum of absolute sparse coefficient differences, and event change ratio in sparse representation domain.

At block 412 of the method 400, key events are identified from the visual track. The shot detection technique may be used to divide the visual track into a plurality of sparse video segments. These sparse video segments may be analyzed and the sparse video segments important for the plot of the visual track, are identified as key events. In one implementation, the sparse coding based skimming module 222 may identify the key events from the visual track using a sparse coding of scene transitions of the visual track.

At block 414 of the method 400, the key events are summarized to generate a video skim. A video skim may be indicative of a short video clip highlighting the entire video track. User inputs, preferences, and feedbacks may be taken into consideration to enhance users' experience and meet their demand. In one implementation, sparse coding based skimming module 222 may synthesize the key events to generate a video skim.

Referring to FIG. 5, at block 502 of the method 500, multimedia content is retrieved from the index data 232. The retrieved multimedia content may be clustered or non-clustered. In one implementation, the DRM module 224 of the media classification system 104, hereinafter referred as internet DRM may retrieve the multimedia content for management of digital rights. The internet DRM may be used for sharing online digital contents such as mp3 music, mpeg videos etc. In another implementation, the DRM module 224 may be integrated within the user device 108. The DRM module 224 integrated within the user device 108 may be hereinafter referred to as mobile DRM 224. The mobile DRM utilizes hardware of the user device 108 and different third party security license providers to deliver the multimedia content securely.

At block 504 of the method 500, the multimedia content may be protected by watermarking methods. The watermarking methods may be audio and visual watermarking methods based on sparse representation and empirical mode decomposition techniques. In digital watermarking technique, a watermark, such as a pseudo noise is added to the multimedia content for identification, tracing and control of piracy. Therefore, authenticity of the multimedia content is protected and secured from attacks of illegitimate users, such as mobile users. Further, a watermarking of the multimedia content may be generated using the characteristics of the multimedia content. In one implementation, the DRM module 224 may protect the multimedia content using a sparse watermarking technique and a compressive sensing encryption technique.

At block 506 of the method 500, the multimedia content is secured by controlling access to the multimedia content. Every user may be provided with user credentials, such as a unique identifier, a username, a passphrase, and other user-linkable information to allow them to access the multimedia content. In one implementation, the DRM module 224 may secure the multimedia content by controlling access to the tagged multimedia content.

At block 508 of the method 500, the multimedia content is encrypted and stored. The multimedia content may be encrypted using sparse and compressive sensing based encryption techniques. In an implementation, the encryption techniques for the multimedia content may employ scrambling of blocks of samples of the multimedia content in both temporal and spectral domains and also scrambling of compressive sensing measurements. Further, a multi-party trust based management system may be used that builds a minimum trust with a set of known users. As time progresses, the system builds a network of users with different levels of trust used for monitoring user activities. This system is responsible to monitor activities and re-assign the level of trust to users. The re-assigning of level means to increase or decrease it. In one implementation, the DRM module 224 may encrypt and store the multimedia content.

At block 510 of the method 500, access to the multimedia content is allowed to an authenticated and an authorized user. The multimedia content may be securely retrieved. In one implementation, the DRM module 224 may authenticate a user to allow him access the multimedia content. In an implementation, the user may be authenticated using sparse coding based user-authentication method, where spare representation of extracted features is processed for verifying user credentials.

Referring to FIG. 6, at block 602 of the method 600, authentication details may be received from a user. The authentication details may include user credentials, such as unique identifier, username, passphrase, and other user-linkable information. In an implementation, the DRM module 224 may receive the authentication details from the user.

At block 604 of the method 600, it is ascertained whether the authentication details are valid or not. In an implementation, the DRM module 224 may determine whether the authentication details are valid. If it is determined that the authentication details are invalid, the method 600 proceeds back to block 602 (‘No’ branch) and the authentication details are again received from the user.

However, if at block 602, it is determined that the authentication details are valid, the method 600 proceeds to block 606 (‘Yes’ branch). At block 606 of the method 600, a mixed reality multimedia interface 110 is generated for the user to allow access to the multimedia content stored in the index data 232. In one implementation, the mixed reality multimedia interface 110 is generated by the index generation module 220 of the media classification system 104.

At block 608 of the method 600, it is determined whether the user wants to change the view or the display settings. If it is determined that the user wants to change the view or the display settings, the method 600 proceeds to block 610 (‘Yes’ branch). At block 610, the user is allowed to change the view or the display settings after which the method proceeds to the block 612.

However, if at block 608, it is determined that the user does not want to change the view/display settings, the method 600 proceeds to block 612 (‘No’ branch). At block 612 of the method 600, the user is prompted to browse the mixed reality multimedia interface 110, select and play the multimedia content.

At block 614 of the method 600, it is determined whether the user wants to change settings of the multimedia content. If it is determined that the user wants to change the settings of the multimedia content, the method 600 proceeds to block 612 (‘Yes’ branch). At block 612, the user is facilitated to change the multimedia settings by browsing the mixed reality multimedia interface 110.

However, if at block 614, it is determined that the user does not want to change the settings of the multimedia content, the method 600 proceeds to block 616 (‘No’ branch). At block 616 of the method 600, it is ascertained whether the user wants to continue browsing. If it is determined that the user wants continue browsing, the method 600 proceeds to block 606 (‘Yes’ branch). At block 606, the mixed reality multimedia interface 110 is provided to the user to allow access to the multimedia content.

However, if at block 616, it is determined that the user does not want to continue browsing, the method 600 proceeds to block 618 (‘No’ branch). At block 618, the user is prompted to exit the mixed reality multimedia interface 110.

Referring to FIG. 7, at block 702 of the method 700, multimedia content is received from the index data 232.

At block 704 of the method 700, the multimedia content is analyzed to generate a deliverable target of quality of the multimedia content that may be provided to a user. The deliverable target based on analyzing multimedia content, processing capability of a user device and streaming capability of the network. In an implementation, the quality of the multimedia content may be determined using quality-controlled coding techniques based on sparse coding compression and compressive sampling techniques. In these quality-controlled coding techniques, optimal coefficients are determined based on threshold parameters estimated for user-preferred multimedia content quality rating. In one implementation, the multimedia classification system 104 may determine the quality of the multimedia content to be sent to the user. For example, the multimedia content may be up-scaled or down-sampled based on the processing capabilities of the user device 108.

At block 706 of the method 700, it is ascertained whether the deliverable target matches the user's requirements. If it is determined the deliverable target does not match with the user's requirements, the method 700 proceeds to block 708 (‘No’ branch). At block 708, suggestive alternative configuration is generated to meet user's requirements. At block 710 of the method 700, a request is received from the user to select the alternative configuration. In one implementation, the QoS module 226 determines whether the deliverable target matches the user's requirements.

However, if at block 706, it is determined that the deliverable target matches with the user requirement, the method 700 proceeds to block 712 (‘Yes’ branch). At block 712 of the method 700, the multimedia content is delivered to the user. In one implementation, the QoS module 226 determines whether the deliverable target matches the user's requirement

At block 714 of the method 700, feedback of the delivered multimedia content is received from the user. At block 716, the delivered multimedia content is monitored. In one implementation, the QoS module 226 monitors the delivered multimedia content and receives a feedback of delivered multimedia content. The delivered multimedia content may be monitored by a monitoring delivered content unit.

At block 718, an evaluation report of the delivered multimedia content is generated based on the feedback received at block 714. In one implementation, the QoS module 226 generates an evaluation report of the delivered multimedia content. The evaluation report may be generated by a statistical generation unit.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method for accessing multimedia content, the method comprising:
receiving a user query for accessing multimedia content of a multimedia class, the multimedia content being associated with a plurality of multimedia classes, and each of the plurality of multimedia classes being linked with one or more portions of the multimedia content;
executing the user query on a media index of the multimedia content;
identifying portions of the multimedia content tagged with the multimedia class based on the execution of the user query;
retrieving a tagged portion of the multimedia content tagged with the multimedia class based on the execution of the user query; and
transmitting the tagged portion of the multimedia content to the user through a mixed reality multimedia interface.

2. The method as claimed in claim 1, further comprising:
receiving authentication details from a user to access the multimedia content;
determining whether the user is authenticated to access the multimedia content, based on the authentication details; and
ascertaining whether the user is authorized to access the multimedia content, based on digital rights associated with tagged multimedia content, wherein the user is authorized based on a sparse coding technique.

3. The method as claimed in claim 1, further comprising:
receiving at least one of a user feedback and a user rating on the tagged multimedia content; and
updating the media index based on at least one of the user feedback and the user rating.

4. The method as claimed in claim 1, further comprising:
receiving the multimedia content from a plurality of media sources;
analyzing the multimedia content to extract at least one feature of the multimedia content; and
tagging the multimedia content into at least one pre-defined multimedia class based on the at least one feature.

5. The method as claimed in claim 4, wherein the analyzing of the multimedia content to extract the at least one feature of the multimedia content further comprises:
converting the multimedia content into a digital format;
splitting the multimedia content to retrieve at least one of an audio track, a visual track, and a text track; and
processing the at least one of an audio track, a visual track and a text track.

6. The method as claimed in claim 5, wherein the processing of the at least one of the audio track, the visual track and the text track comprises:
obtaining the audio track from a media source;
segmenting the audio track into a plurality of audio frames;
analyzing the audio frames to discard silenced frames from amongst the plurality of audio frames;
extracting a plurality of key audio features from amongst the plurality of audio frames;
classifying the audio track into at least one multimedia class based on the plurality of key audio features; and
generating a media index for the audio track based on the at least one multimedia class.

7. The method as claimed in claim 6, wherein the classifying of the audio track into the at least one multimedia class based on the plurality of the key audio features comprises:
accumulating audio format information from the plurality of audio frames;
converting the format of the plurality of audio frames into an application-specific audio format;
detecting a plurality of key audio events based on the plurality of key audio features;
ascertaining the key audio events based on analyzing intra-frames, inter-frames, and inter-channel sparse data correlations of the plurality of audio frames, and
updating the media index based on key audio events.

8. The method as claimed in claim 7, wherein the classifying of the audio track into the at least one multimedia class based on the plurality of the key audio features is based on at least one of acoustic features, a compressive sparse classifier, Gaussian mixture models, and information fusion.

9. The method as claimed in claim 5, wherein the processing of the at least one of the audio track, the visual track and the text track comprises:
obtaining the visual track from a media source;
segmenting the visual track into a plurality of sparse video segments;
extracting a plurality of features from the sparse video segments;
classifying the visual track into at least one multimedia class based on the plurality of features; and
generating a media index for the visual track based on the at least one multimedia class.

10. The method as claimed in claim 5, wherein the processing of the at least one of the audio track, the visual track and the text track, further comprising:
extracting a plurality of low-level features from the visual track, audio track, and the text track;
segmenting the visual track into a plurality of sparse video segments based on the plurality of low-level features;
analyzing the plurality of sparse video segments to extract a plurality of high-level features;
determining a correlation between the plurality of sparse video segments and the visual track based on the plurality of high-level features;
identifying a plurality of key events based on the determining; and
summarizing the plurality of key events to generate a skim.

11. The method as claimed in claim 5, wherein the processing of the at least one of the audio track, the visual track and the text track, comprises:
analyzing the plurality of features extracted from the visual track to determine at least one of a subtitle and a text character from the text track;
extracting a plurality of features from the text track based on the at least one of the subtitle and the text character, wherein the extracting is based on an optical character recognition technique;
classifying the text track into at least one multimedia class based on the plurality of features; and
generating a media index for the text track based on the at least one multimedia class.

12. A user device comprising:
at least one device processor;
a mixed reality multimedia interface coupled to the at least one device processor, the mixed reality multimedia interface configured to:
receive a user query from a user for accessing multimedia content of a multimedia class;
retrieve a tagged portion of the multimedia content tagged with the multimedia class; and
transmit the tagged portion of the multimedia content to the user.

13. The user device as claimed in claim 12, wherein the user device includes at least one of a mobile phone, a smart phone, a Personal Digital Assistants (PDAs), a tablet, a laptop, a home theatre system, a set-top box, an Internet Protocol TeleVision (IP TV), and a smart TeleVision (smart TV).

14. The user device as claimed in claim 12, wherein the mixed reality multimedia interface includes at least one of a touch, a voice, and an optical light control application icons to receive the user query to at least one of extract, play, store, and share the accessing the multimedia content.

15. A media classification system comprising:
a processor;
a segmentation module coupled to the processor, the segmentation module configured to:
segment multimedia content into its constituent tracks;
a categorization module, coupled to the processor, the categorization module configured to:
extract a plurality of features from the constituent tracks; and
classify the multimedia content into at least one multimedia class based on the plurality of features;
an index generation module coupled to the processor, the index generation module configured to:
create a media index for the multimedia content based on the at least one multimedia class; and
generate a mixed reality multimedia interface to allow a user to access the multimedia content; and
a Digital Rights Management (DRM) module coupled to the processor, the DRM module configured to secure the multimedia content, based on digital rights associated with the multimedia content, wherein the multimedia content is secured based on a sparse coding technique and a compressive sensing technique using composite analytical and signal dictionaries.

16. The media classification system as claimed in claim 15, wherein the categorization module is further configured to:
suppress noise components from the constituent tracks based on a media controlled filtering technique, wherein the constituent tracks include a visual track and an audio track;
segment the visual track and the audio track into a plurality of sparse video segments and a plurality of audio segments respectively;
identify a plurality of highly correlated segments from amongst the plurality of sparse video segments and the plurality of audio segments;
determine a sparse coefficient distance based on the plurality of highly correlated segments; and
cluster the plurality of sparse video segments and the plurality of audio segments based on the sparse coefficient distance.

17. The media classification system as claimed in claim 15, wherein the Digital Rights Management (DRM) module is further configured to encrypt the multimedia content using scrambling sparse coefficients based on a fixed or a variable frame size and a frame rate.

18. The media classification system as claimed in claim 15, wherein the segmentation module is further configured to:
determine significant sparse coefficients and non-significant sparse coefficients from the constituent tracks;
quantize and encode the significant sparse coefficients;
form a binary map of the constituent tracks;
compress the binary map of the constituent tracks using a run-length coding technique;
determine optimal thresholds by maximizing compression ratio and minimization distortion; and
assess quality of the compressed constituent tracks.

19. The media classification system as claimed in claim 15, further comprising a Quality of Service (QoS) module, coupled to the processor, configured to:
receive at least one of a user feedback and a user rating on the classified multimedia content; and
update the media index based on at least one of the user feedback and the user rating.
